(19) United States
(12) Patent Application Publication
(10) Pub. No.: US 2004/0138964 A1
(43) Pub. Date: Jul. 15, 2004

(54) Print system which accesses a web page on which a consumable item is purchasable

(76) Inventors: Hiroshi Okada, Nagano-ken (JP); Masumi Yoshino, Nagano-ken (JP)

Correspondence Address: Jonathan P. Osha, Rosenthal & Osha L.L.P., Suite 2800, 1221 McKinney St., Houston, TX, 77010, US

(21) Appl. No.: 10/695,639

(22) Filed: Oct. 28, 2003

(30) Foreign Application Priority Data
Oct. 30, 2002 (JP) 2002-315869
Aug. 6, 2003 (JP) 2003-206287

(51) Int. Cl. G06F 17/60

(52) U.S. Cl. 705/27

(57) ABSTRACT

A recording medium is provided, which records a program executable on a computer connected to a printer which conducts printing by use of a consumable item, wherein, the program allows the computer to execute, a receiving process which receives from a user an input of a country/region where the printer is used, a storing process which stores a URL being associated with the country/region in the input thus received, with reference to data where the country/region and the URL are associated with each other in advance, and an obtaining process which obtains information regarding a consumption degree of the consumable item used in the printer, and an accessing process which accesses a Web site where the consumable item is purchasable, the Web site being identified by the URL thus stored, when the consumption degree meets a standard which is obtained by a predetermined rule. With the recording medium as described above, it is possible to achieve a commonality in a program which executes a process for accessing the Web page where a consumable item is purchasable according to a degree of consumption of the consumable item, irrespective of a country/region for distributing the program.

### FIELD OF THE INVENTION

The present invention relates to a print system which accesses a Web page on which a consumable item is purchasable, according to a degree of consumption of the consumable item.

### DESCRIPTION OF THE RELATED ART

The Japanese Patent Application Laid-open No. 2002-123384 discloses a program as described below, so that a user is easily able to purchase a consumable item, for example, an ink cartridge to be used in a print device such as a printer. Specifically, according to the program, when an ink remaining amount in the ink cartridge reaches equal to or less than the predetermined threshold, a screen inviting a purchase of a new ink cartridge is displayed, allowing an access from the screen to a Web page where online purchase of the new ink cartridge is possible.

Further, the Japanese Patent Application Laid-Open No. 2001-344203 discloses that a universal Web page irrespective of country/region is firstly accessed, so as to achieve a common program that executes a process for accessing Web pages, each created by country/region.

### SUMMARY OF THE INVENTION

Currently, Web pages where an online purchase of a consumable item, such as ink cartridge, is possible are respectively established by dealers located throughout the world. When the above program detects that the ink remaining amount becomes less, it accesses any one of the Web pages to invite a user to purchase an ink cartridge.

At this stage, it is desirable for a user who utilizes the printer in one country, to access the Web page established by the dealer belonging to that country, because of smoothness in procedure and convenience in delivery and the like.

Therefore, the program distributed in that country is required to include in advance a command to access the Web page established by the dealer belonging to that country. Since the program is distributed under a condition that the Web page, which is to be accessed from each country, is previously set in the program, resulting that the content of the program is different for each country.

However, considering a development cost and a product management and the like, it is desirable to achieve a commonality in the program as much as possible, which is distributed in each country.

An object of the present invention is to achieve such commonality in the program, which executes a process for accessing a Web page where a consumable item is purchasable according to a degree of consumption of the consumable item, irrespective of country/region where the program is distributed.

In order to achieve the object above, the present invention provides a recording medium as the following. That is, a recording medium which records a program executable in a computer connected to a printer which conducts printing by use of a consumable item, wherein, the program allows the computer to perform,

a receiving process which receives from a user an input of a country/region where the printer is used,

a storing process which stores a URL (Uniform Resource Locators) being associated with the country/region in the input thus received, with reference to data where the country/region and the URL are associated with each other in advance,

an obtaining process which obtains information regarding a consumption degree of the consumable item used in the printer, and

an accessing process which accesses a Web site where the consumable item is purchasable, the Web site being identified by the URL thus stored, when the consumption degree meets a standard which is obtained by a predetermined rule.

According to the present invention, it is possible to receive from a user an input of a country/region where the printer is used, and to set a URL to be accessed corresponding to the country/region thus received, whereby a commonality is achieved in a program which executes a process for accessing a Web page where a consumable item is purchasable, irrespective of the country/region where the program is distributed.

Here, a process for accessing the Web site where the consumable item is purchasable can be performed based on a user instruction. It is because there may be a case that the user does not desire an access to the Web site where the consumable item is purchasable.

Further, it is desirable to allow the computer to execute at the time of installing the program, the receiving process which receives from a user an input of a country/region where the printer is used, and the storing process which stores the URL being associated with the country/region in the input thus received. With such a procedure, it is possible to reduce burdens on the user.

Further, instead of the process which receives from a user an input of a country/region where the printer is used, it may be also possible to allow the computer to execute a process for receiving the input of the URL, and to allow the computer to execute the process of storing the URL thus received, instead of the process which stores the URL being associated with the country/region in the input thus received. With such a procedure, it is possible for a user to set an arbitrary URL.

The process which receives from a user an input of a country/region where the printer is used, is also capable of displaying countries/regions in a selectable manner, based on data where the countries/regions are respectively associated with URL (Uniform Resource Locators) in advance. Accordingly, a selection of the country/region is simplified.

At this stage, the computer is allowed to further execute a process which obtains country information set in the computer, and then, the process which receives from a user an input of a country/region where the printer is used, is also capable of displaying the country/region under a condition that the country corresponding to the country information thus received is already selected. Accordingly, a selection of the country/region is further simplified, as well as reducing burdens on the user.

It is to be noted that the consumable item may be assumed to be an ink cartridge, and the consumption degree of the consumable item may be assumed to be expressed by an ink remaining amount.

Further according to the present invention, a printer host and a method are provided as the following. That is, a printer host connected to a printer which conducts printing by use of a consumable item, comprising,

a receiving means which receives from a user an input of a country/region where the printer is used,

a storing means which stores a URL being associated with the country/region in the input thus received, with reference to data where the country/region and the URL (Uniform Resource Locators) are associated with each other in advance,

an obtaining means which obtains information regarding a consumption degree of the consumable item used in the printer, and

an accessing means which accesses a Web site where the consumable item is purchasable, the Web site being identified by the URL thus stored, when the consumption degree meets a standard which is obtained by a predetermined rule.

The method which accesses a Web page where a consumable item is purchasable according to a consumption degree of a consumable item used in the printer, including,

a storing process which receives from a user an input of the country/region where the printer is used, and stores a URL being associated in advance with the country/region in the input thus received,

an obtaining process which obtains information regarding the consumption degree of the consumable item, and

an accessing process which accesses the Web site where the consumable item is purchasable, the Web site being identified by the URL thus stored, when the consumption degree meets a standard which is obtained by a predetermined rule.

### BRIEF DESCRIPTION OF THE DRAWINGS

FIG. 1 is a block diagram schematically showing a configuration of the present invention.

FIG. 2 is a block diagram schematically showing a hardware configuration of a print system 1.

FIG. 3 is an illustration schematically showing a print engine 15.

FIG. 4 is a diagram explaining a process when a printer utility program is installed in a computer 30.

FIG. 5 is a flow diagram explaining a process of an initial setting module 91.

FIG. 6 is an illustration showing a printer utility initial setting screen 400.

FIG. 7 is an illustration showing a printer utility initial setting screen 420 where it is possible for a user to set a URL arbitrarily.

FIG. 8 is a block diagram showing a characteristic functional configuration established on the print system 1.

FIG. 9 is an illustration showing an example of an ink monitor screen 500.

FIG. 10 is a flow diagram explaining a process of a printer utility section 312.

### DETAILED DESCRIPTION OF THE PREFERRED EMBODIMENTS

Preferred embodiments of the present invention will be explained with reference to the attached drawings.

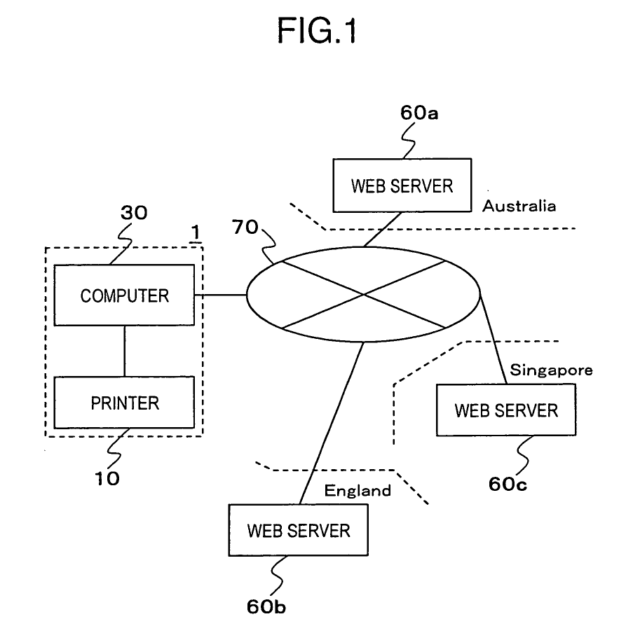

FIG. 1 is a block diagram schematically showing a configuration of the present invention. A print system 1 comprising a computer 30 and a printer 10 is connected to a computer network, for example, the Internet 70, and it is designed so that various services provided on the Internet 70 are available, for example, browsing a Web page, transmitting/receiving electronic information and the like.

The Internet 70 is connected to Web servers 60a, 60b, 60c, and so on, each establishing a Web site. On the Web site which is established by the Web server 60, there is provided a service to receive an online request for purchasing a consumable item used in the printer 10, such as an ink cartridge. Here, it is assumed that the Web servers 60a, 60b, and 60c and so on respectively provide services in different countries/regions (hereinafter, it will be summarized as “countries” or “country”).

A URL (Uniform Resource Locators) for requesting a purchasing a consumable item is set in the print system 1. When an ink remaining amount of the ink cartridge becomes less, a screen for accessing the Web page is displayed, so as to invite a user to request a purchase of an ink cartridge. Hereinafter, as a way of example, the ink cartridge is assumed to be a consumable item. However, the consumable item is not limited to the ink cartridge only. The present invention is also applicable to the case where the consumable item is a toner cartridge, a photoconductor drum or other printer consumable items.

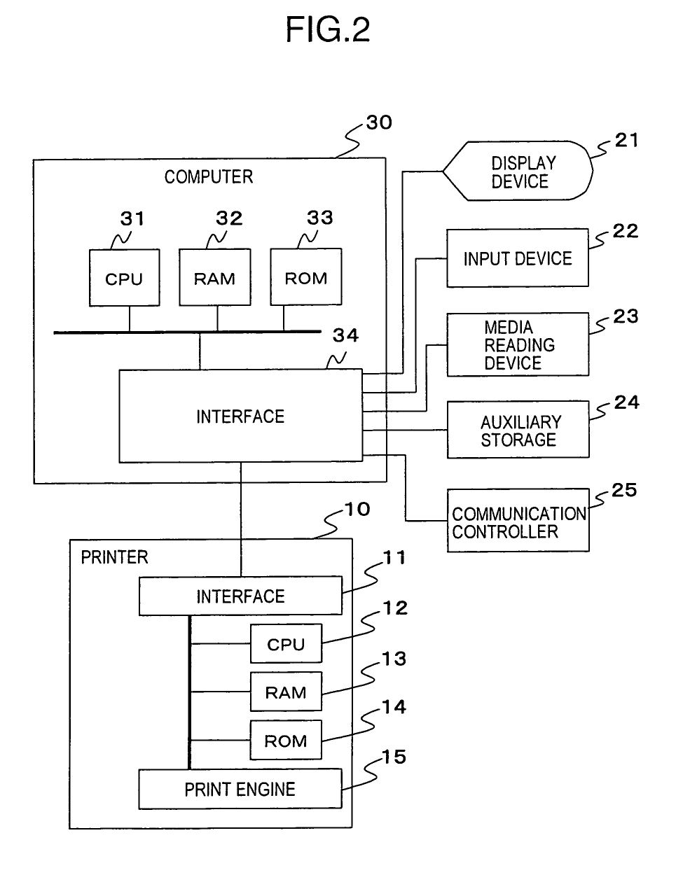

FIG. 2 is a block diagram schematically showing a hardware configuration of the print system 1, comprising a computer 30 functioning as a printer host and a printer 10 which is a print device.

The computer 30 comprises CPU (Central Processing Unit) 31 which executes a process based on various programs, RAM (Random Access Memory) 32 which temporarily stores data, programs and so on, ROM (Read Only Memory) 33 which previously stores in nonvolatile manner various data, starting programs and the like for controlling the computer 30, and an interface 34 which controls data transmission/reception with peripheral devices, such as a printer 10 thus connected.

The computer 30 is further connected to a display device 21 such as a color display, an input device 22 such as a mouse and a keyboard, a media reading device 23 which reads data from a recording medium such as CD-ROM, an auxiliary storage 24, being internal or external, and a communication controller 25 to establish a connection with the Internet 70. It is to be noted that the computer 30 is not limited to the above configuration.

The printer 10 is, for example, a color printer of ink-jet type. The color printer of ink-jet type comprises a plurality of ink cartridges, each being a case filled with ink. Printing is conducted by spraying the ink from a print head onto the medium to be printed, such as recording paper.

The printer 10 comprises an interface 11 which conducts a communication, such as data reception, with the computer 30, CPU 12 which executes a process based on various programs, RAM 13 which temporarily stores print data and the like, ROM 14 which stores various data and various programs and the like in non-volatile manner so as to control the printer 10, a print head which discharges ink, a carriage driving mechanism which drives a carriage mounting the print head, and a print engine 15 including a paper feed mechanism, and a paper feed/eject mechanism and the like, which performs paper feeding and ejecting process as to the medium to be printed. It is to be noted that the printer 10 is not limited to the above configuration.

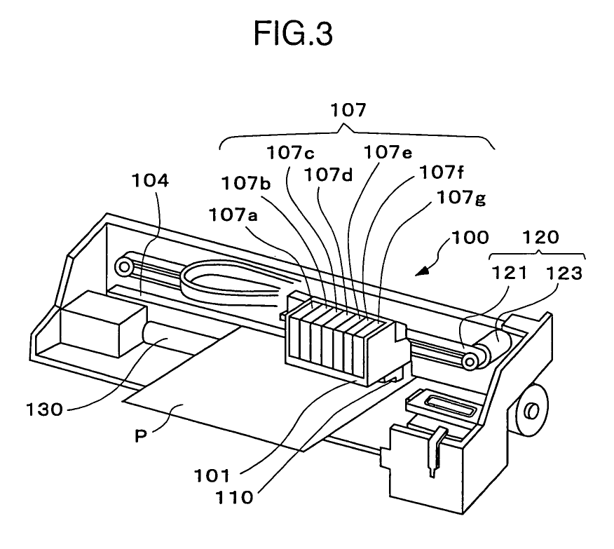

FIG. 3 is an illustration schematically showing the print engine 15. As shown in FIG. 3, the print engine 15 comprises a carriage 101 mounting a plurality of ink cartridges 107 (107a to 107g), a print head 110 of ink-jet type which is supported by the carriage 101, a carriage mechanism 120 which supports the carriage 101 and also gives it a reciprocating motion in a line direction, and a paper feed mechanism 130 for feeding paper P.

The carriage mechanism 120 comprises a timing belt 121 coupled to the carriage 101 and a carriage motor 123 which gives a reciprocating motion to the timing belt 121. The carriage motor 123 gives a reciprocating motion to the carriage 101 via the timing belt 121, in the paper width direction of the recording paper P, guided by the guide member 104.

On the carriage 101, the print head 110 of ink-jet type is mounted on a surface opposing to the recording paper P, which is a bottom surface of the carriage 101 in FIG. 3. The print head 110 is held on the carriage 101. The print head 110 is replenished with ink from the cartridge 107, and forms dots on the recording paper P by discharging ink drops according to a movement of the carriage 101, whereby an image, character and the like are printed on the recording paper P.

The ink cartridges 107a to 107g are independently mounted, and an ink accommodating chamber formed in each ink cartridge is replenished with Black (K) ink or color ink. The color ink may be any one of Cyan (C), Light Cyan (LC), Mazenda (M), Light Mazenda (LM), Yellow (Y), and Dark Yellow (DY). It may also be possible to replenish one ink cartridge 107 with a plurality of colors.

In the present embodiment, the carriage 101 is capable of mounting seven units of ink cartridges 107, and Black (B) ink and other colors are respectively mounted in the seven mounting positions.

The positions of the respective ink cartridges 107 are predetermined. For example, on six positions out of the seven positions, Yellow (Y), Light Mazenda (LM), Mazenda (M), Light Cyan (LC), Cyan (C) and Black (K) are mounted in this sequence. It is determined that the ink cartridge of either Black (K) or Dark Yellow (DY) is mounted on the remaining one position. This is because the Dark Yellow (DY) is a color ink to enhance a quality in printing, and it is not necessarily required depending on a purpose for printing or a type of print medium. Therefore, it is designed so that a user can mount selectively, either Black (K) which is frequently used or the Dark Yellow (DY).

On the print head 110, nozzle openings (not illustrated) corresponding to the seven ink cartridges 107, are respectively arranged in rows.

Each of the ink cartridges 107 is provided with a storage element. In the storage element, there are stored information indicating the color of the ink replenishing each of the ink cartridges 107 and information indicating the ink remaining amount. It is also possible to store information regarding a type, a version, a manufacturer, time of manufacturing and the like, of the ink cartridge.

A connecting terminal is exposed on the storage element, and it comes into electrically contact with an electrode provided on the carriage 101, when the ink cartridges 107 are mounted on the printer 10. With this structure, it is possible to give and receive information such as ink colors and ink remaining amount between the printer 10 and each of the ink cartridges 107. The storage element can be configured by EEPROM (Electronically Erasable and Programmable Read Only Memory) comprising a memory cell, a read/write controller, an address counter and the like.

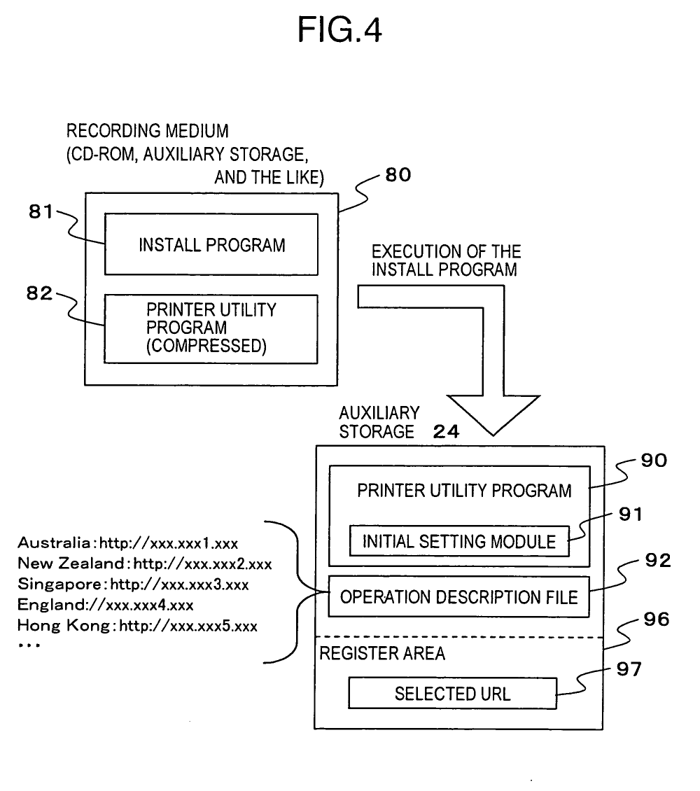

Next, with reference to FIG. 4, a process when a printer utility program, to which the present invention is applied, is installed in the computer 30 will be explained.

The printer utility program 82 is in a compressed condition and recorded in the recording medium 80 together with an install program 81. The recording medium 80 may be a CD-ROM, for example. If the printer utility program 82 and the install program 81 are downloaded via the Internet 70 and the like, an auxiliary storage 24 substitutes for the recording medium 80.

A user executes the install program 81 and expands the printer utility program 82 thus compressed, so as to record the printer utility program 82 on the auxiliary storage 24. On the auxiliary storage 24, a register area 96 is provided for storing various setting matters to be used in the process in the computer 30.

When the install program 81 is executed, the printer utility program 90 including an initial setting module 91 and an operation description file 92 of the printer utility program 90 are constructed in the auxiliary storage 24.

In the operation description file 92, there are recorded a plurality of combinations between a country identifier and a URL of the Web site providing a service for receiving a purchase request of ink cartridge in the corresponding country. These combinations are created in advance by a developer of the printer utility program 90.

After the install program 81 records the printer utility program 90 in the auxiliary storage 24, it starts up the initial setting module 91, which is included in the printer utility program 90.

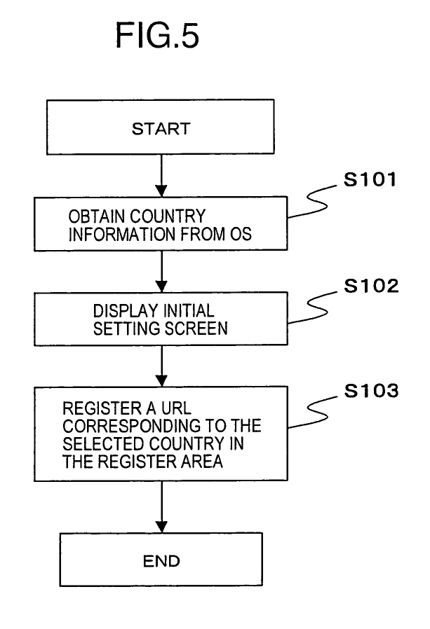

FIG. 5 is a flow diagram explaining a process of the initial setting module 91.

The initial setting module 91 of the printer utility program 90 firstly attempts to obtain from an operating system, country information set therein, the operating system being for controlling basic processing operations of the computer 30 (S101) The country information set in the operating system will be explained below.

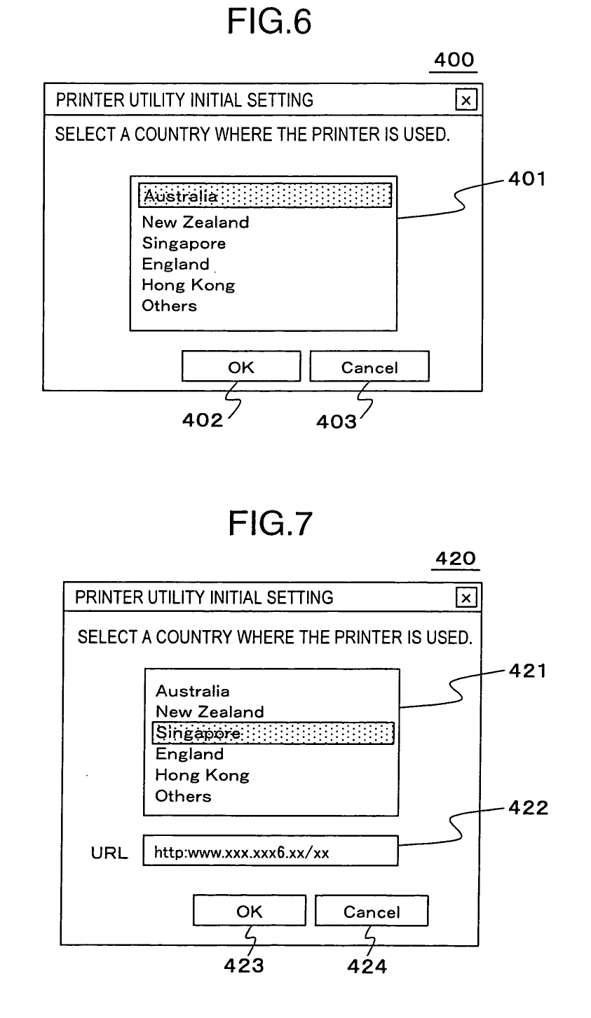

Next, the initial setting module 91 displays a printer utility initial setting screen 400, as shown in FIG. 6, on the display device 21 (S102).

The printer utility initial setting screen 400 comprises an area for setting a country 401 where the print system 1 (printer 10) is used, an “OK” button 402, and a “Cancel” button 403. The initial setting module 91 displays the country identifiers (country names) recorded in the operation description file 92 in a selectable manner in the area for setting a country 401. The user is able to select a country where the print system 1 is used, out of the country identifiers displayed in the area for setting a country 401.

At this stage, the initial setting module 91 displays the country identifier which corresponds to the country information obtained in step S101, in highlighted manner indicating that it is to be selected, thereby reducing a bother for the user to select the country.

There may be a case that such country information cannot be obtained according to a type of the operating system, or a status of the print system 1. Also, there may be a case that a country identifier corresponding to the obtained country information does not exist in the operation description file 92. In the case above, the item “Others” indicating other countries, is displayed in highlighted manner in the area for setting a country 401.

On the other hand, there may be a case that the obtained country information matches the country where the print system 1 is used with a high degree of certainty, according to a type of the operating system, a status of the print system 1, or a country where the print system 1 is used. In such a case, the obtained country information is assumed to be selected by the user, and executes the following process without displaying the initial setting screen 400 to receive a setting from the user.

When the initial setting module 91 of the printer utility program 90 receives a click on the “OK” button 402 in the printer utility initial setting screen 400, it obtains from the operation description file 92 a URL corresponding to the country identifier, which is selected in the area for setting a country 401. Then, the obtained URL is recorded in the register area 96 as a selected URL 97 (S103).

As described above, since the URL is set so that it corresponds to the country where the print system 1 is used, the printer utility program 90 can be developed to have a commonality irrespective of the country where the program is distributed.

Here, the URL which is recorded as the selected URL 97 in the register area 96 may be arbitrarily set by a user.

FIG. 7 shows a printer utility initial setting screen 420 which is designed so that the user can arbitrarily set the URL. As shown in FIG. 7, the printer utility initial setting screen 420 comprises an area for setting a country 421, an “OK” button 423, a “Cancel” button 424 and further, a URL setting field 422.

The user can select a country where the print system 1 is used, out of the country identifies displayed on the area for setting a country 421, on the print utility initial setting screen 420, whereby it is possible to set a URL which is fixed in advance. Alternatively, the user can set a URL in the URL setting field 422, and then the URL other than the fixed ones can be set.

When the initial setting module 91 of the printer utility program 90 receives a click on the “OK” button 423, and a URL is set in the URL setting field 422, the initial setting module 91 records in the register area 96 the URL in the URL setting field 422 as a selected URL 97. On the other hand, if no URL is set in the URL setting field 422, the initial setting module 91 obtains from the operation description file 92 a URL corresponding to the country identifier selected in the area for setting a country 421, and records the obtained URL as the selected URL 97 in the register area 96.

Here, the URL recorded in the register area 96 may be modified after the installation process. Alternatively, the installation process may be re-executed for the modification.

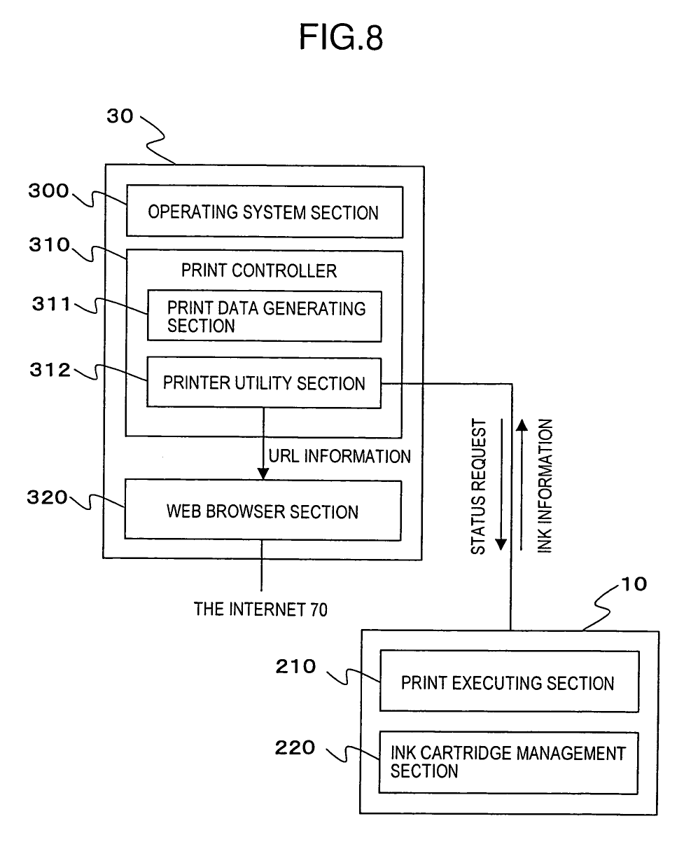

FIG. 8 is a block diagram showing a characteristic functional configuration established on the print system 1, after the printer utility program 90 is installed.

In FIG. 8, on the computer 30, there are established an operating system section 300 which controls basic processing operations of the computer 30, a print controller 310 which controls a print process in the computer 30, and a Web browser section 320 which executes a process for accessing the Web page. On the printer 10, there are established a print executing section 210 which executes an actual print process and an ink cartridge management section 220.

The operating system section 300 is established on the computer 30 by the operating system which is basic software. The operating system section 300 manages information as to countries where the computer 30 is used, so as to manage, for example, a language process and time zone, etc., in the computer 30.

The print controller 310 comprises a print data generating section 311 which generates print data regarding a document to be printed, and a printer utility section 312 which executes a process such as managing the ink cartridges 107 mounted on the printer 10.

The print data generating section 311 creates print data as to the document to be printed, by executing rasterizing process, color conversion process, and the like.

At the time of print execution, the printer utility section 312 obtains the ink remaining amount of the ink cartridges 107 mounted on the printer 10. If the ink remaining amount of any one of the ink cartridges is less than a threshold fixed by a predetermined rule (hereinafter, referred to as “target threshold”), an ink monitor screen is displayed on the display device 21, which invites the user to purchase an ink cartridge.

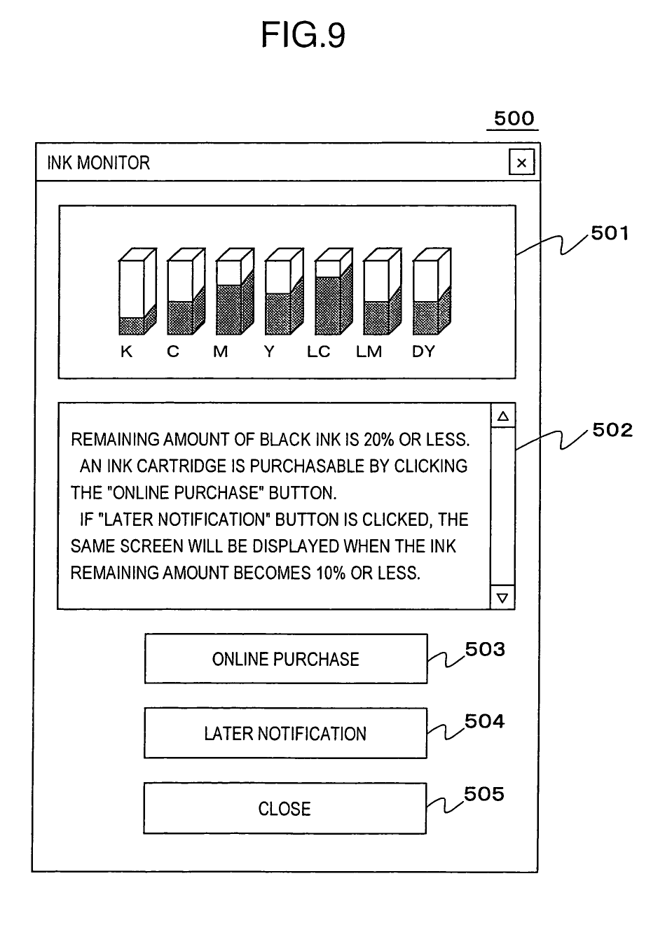

FIG. 9 is an illustration showing an example of the ink monitor screen 500. In FIG. 9, the ink monitor screen 500 comprises an ink remaining amount display field 501 which visually displays the ink remaining amount of each ink cartridge, a field 502 for giving explanations about the ink remaining amount, “Online purchase” button 503, “Later notification” button 504, and “Close” button 505.

When the printer utility section 312 receives a click on the “Online purchase” button 503 in the ink monitor screen 500, it notifies the Web browser section 320 of the URL of the Web page for requesting a consumable item purchase. Then, the Web browser section 320 accesses the Web page for requesting the consumable item purchase, whereby the user can make online request for purchasing the ink cartridge. A URL which is set at the time of installation process of the printer utility program 90 is used as the URL of the Web page for requesting for the consumable item purchase.

When the printer utility section 312 receives a click on the “Later notification” button 504 in the ink monitor screen 500, the printer utility section 312 once closes the ink monitor screen 500. Further, when the ink remaining amount is reduced and becomes equal to or less than the next target threshold, the ink monitor screen 500 is again displayed on the display device 21.

In other words, in the present embodiment, plural values can be set as the target threshold of the ink remaining amount, which is a reference for displaying the ink monitor screen 500. Four values may be set as the target threshold, for example, 20%, 10%, 5%, and 0%. It is to be noted that the values themselves, and the piece number of values, which can be set as the target threshold, are not limited to above.

For example, when the ink remaining amount of one ink cartridge 107 becomes 20%, the printer utility section 312 displays the ink monitor screen 500 and invites a purchase of an ink cartridge. Upon receipt of click on the “Later notification” button 504 in the ink monitor screen 500, the printer utility section 312 closes the ink monitor screen 500, and set “10%” as the target threshold, which is one level lower than “20%”. The ink is consumed further, and when the ink remaining amount of the ink cartridge 107 becomes “10%”, the printer utility section 312 displays again the ink monitor screen 500, and invites a purchase of the ink cartridge 107. Hereinafter, every time when the “Later notification” button 504 is received, the target threshold is reset to be lower, level by level up to 0%.

The target threshold is set for each ink cartridge, and when the ink remaining amount of any one of the ink cartridges 107 becomes equal to or less than the target threshold, which is set in the pertinent ink cartridge, the ink monitor screen 500 is displayed.

When the printer utility section 312 receives a click on the “Close” button 505 in the ink monitor screen 500, it closes the ink monitor screen 500. In this case, the target threshold is not changed. Therefore, if the ink cartridge 107 is not replaced, the ink monitor screen 500 is displayed again at the time of next execution of printing.

The print controller 310 is established on the computer 30, when the CPU 31 executes a printer driver program and the printer utility program, which are read by the RAM 32, on the operating system which controls the computer 30. Such printer driver program and the printer utility program can be distributed by recording on a movable recording medium, for example, on a CD-ROM. Further, it is also possible to be distributed via the Internet 70.

The Web browser section 320 performs a process for accessing a Web page on the Internet 70, which is identified by the URL. The Web browser section 320 can be established by executing generally used software for Web browsing on the computer 30.

The print executing section 210 established on the printer 10 performs an actual printing process, based on print data transmitted form the computer 30.

The ink cartridge management section 220 manages ink information including the ink remaining amount of each ink cartridge 107, being mounted on the printer 10. The ink cartridge management section 220 reads the information from the storage element of each ink cartridge 107, and updates the ink information. Then, upon request from the computer 30, the ink cartridge management section 220 transmits the ink information.

The ink cartridge management section 220 is capable of calculating an ink discharge amount, by multiplying the volume of ink drop discharged from the nozzles mounted on the print head 110, by the discharged times of the ink drops. The ink cartridge management section 220 is also capable of calculating the ink remaining amount, by subtracting from the full ink amount of each ink cartridge 107, the consumed ink amount which is based on the above ink discharge amount and absorbed ink amount, which is consumed by being absorbed upon cleaning and the like of the print head 110.

The ink cartridge management section 220 reads out the ink remaining amount data which is stored in the storage element of each ink cartridge 107 and writes the data in the RAM 13, when the power of the printer 10 is turned on. Then, the contents in the RAM 13 are updated with the latest calculated ink remaining amount, as the ink remaining amount data. When information relating to a type, a version, a manufacturer and manufacturing date of each ink cartridge 107 is recorded in the storage element of each ink cartridge 107, such information may also be written in the RAM 13 at the time the power of the printer 10 is turned on.

The latest ink remaining amount of thus calculated is written in each storage element of the ink cartridges 107, after turning-off operation of the power of the printer 10. Alternatively, it may be written in the storage element for each completion of printing, for example.

Here, it is possible to express the ink remaining amount, for example, on percentage with respect to the ink amount replenished in a brand new ink cartridge. In this case, in the initial status when the ink cartridge 107 is replenished with ink, the ink remaining amount is 100%, and it is decreased to 0%, as the printing process is executed. It is a matte of course that a way of expressing the ink remaining amount is not limited to the percentage.

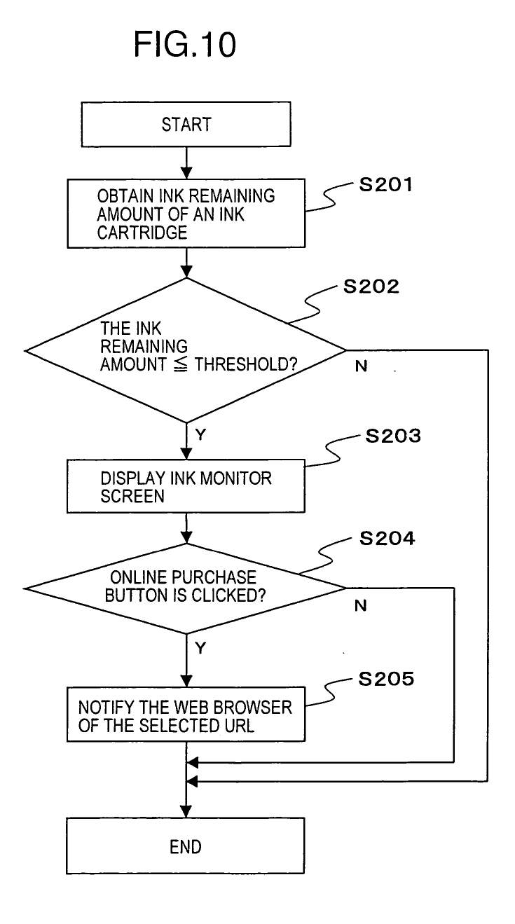

Next, with reference to the flow diagram in FIG. 10, a process of the printer utility section 312 will be explained. This process is executed when the computer 30 obtains a status of the printer 10. Timing when the computer 30 obtains the status of the printer 10 can be, for example, at the time when the printing starts based on a printing instruction from a user, when the computer receives a command for obtaining the printer status from the user, and the like.

The printer utility section 312 obtains the ink remaining amount of each of the ink cartridges 107 from the ink cartridge management section 220 of the printer 10 (S201).

Then, it is determined whether or not the ink remaining amount of any of the ink cartridges becomes equal to or less than the target threshold (S202).

As a result, if the ink remaining amount of any of the ink cartridges 107 does not become equal to or less than the target threshold, the process is completed.

On the other hand, if the ink remaining amount of any of the ink cartridges 107 becomes equal to or less than the target threshold, the ink monitor screen 500 is displayed on the display device 21 (S204). At this stage, in the field 502 for giving explanations about the ink remaining amount, an explanation regarding the ink cartridge whose ink remaining amount becomes equal to or less than the threshold is displayed. If there are plural ink cartridges, each ink remaining amount being equal to or less than the threshold, explanations about each of the ink cartridges are displayed in the filed 502.

Further, in the field 501 where the ink remaining amount of each ink cartridge is visually displayed, the ink remaining amount of each of the ink cartridges 107 is displayed, based on the ink remaining amount value that is obtained in the process (S201). Accordingly, the user can also perceive the ink remaining amount of the ink cartridges 107, whose ink remaining amount is still more than the target threshold.

When a click on the “Online purchase” button 503 is received in the ink monitor screen 500 (S204: YES) the printer utility section 312 notifies the Web browser section 320 of the URL which is recorded in the register area 96 as a selected URL (S205).

Then, the Web browser section 320 accesses the Web site which is indicated by the URL thus notified.

Further, in the ink monitor screen 500, when a click on a button other than the “Online purchase” button 503 is received, the processes respectively corresponding to those buttons are performed. In other words, when a click is received on the “Later notification” button 504, the target threshold is reset to another level. When a click on the “Close” button 505 is received, the ink monitor screen 500 is closed without resetting the target threshold. Then, this process is completed.

In the present embodiment, URL information corresponding to a country is set in the initial setting process for installing the printer utility program in the computer 30. However, the timing for setting the URL information corresponding to the country is not limited to above. For example, it may be set when a first online purchase is made.

In the case above, at the initial setting process for the installation, the initial setting process is completed without performing the processes S101 to S103 as shown in FIG. 5.

Then, when the ink remaining amount of any of the ink cartridges 107 becomes equal to or less than the target threshold, and a click on the “Online purchase” button 503 is received in the process S204 as shown FIG. 10 (S204: YES), the printer utility section 312 checks whether or not the selected URL is recorded in the register area 96.

Consequently, when the selected URL is recorded in the register area 96, the process S205 and the subsequent processes are performed, similar to the above embodiment.

On the other hand, if the selected URL is not recorded in the register area 96, the processes S101 to S103 as shown in FIG. 5 are performed, and a selected URL is recorded in the register area 96. Then, the process S205 and the subsequent processes are performed, similar to the above embodiment.

What is claimed is:

1. A recording medium which records a program to be executed on a computer connected to a printer which conducts printing by use of a consumable item, wherein, said program allows the computer to executes,
a receiving process which receives from a user an input of a country/region where said printer is used,
a storing process which stores a URL (Uniform Resource Locators) being associated with said country/region in the input thus received, with reference to data where the country/region and the URL are associated with each other in advance,
an obtaining process which obtains information regarding a consumption degree of the consumable item used in the printer, and
an accessing process which accesses a Web site where the consumable item is purchasable, the Web site being identified by said URL thus stored, when the consumption degree meets a standard which is obtained by a predetermined rule.

2. A recording medium according to claim 1, wherein, said accessing process which accesses the Web site where the consumable item is purchasable is performed by an instruction from a user.

3. A recording medium according to claim 1, wherein,
said program allows the computer to execute said receiving process which receives from the user the input of the country/region where said printer is used, and said storing process which stores the URL being associated with the country/region in the input thus received, at a time when said program is installed.

4. A recording medium according to claim 1, wherein,
said program allows the computer to execute a process for receiving an input of the URL, instead of said receiving process which receives from the user the input of a country/region where said printer is used, and allows the computer to execute a process for storing the URL thus received, instead of said storing process which stores the URL being associated with the country/region in the input thus received.

5. A recording medium according to claim 1, wherein,
said receiving process which receives from the user the input of the country/region where said printer is used displays the country/region in selectable manner, based on said data where the country/region and the URL (Uniform Resource Locators) are associated with each other in advance.

6. A recording medium according to claim 5, wherein,
said program further allows the computer to execute a process which obtains country information set in said computer, and said receiving process which receives from the user the input of the country/region where said printer is used displays the country/region under a condition that a country corresponding to the country information thus obtained is being selected.

7. A recording medium according to claim 1, wherein,
said consumable item is an ink cartridge, and the consumption degree of said consumable item is expressed by an ink remaining amount.

8. A printer host connected to a printer which conduct printing by use of a consumable item, comprising,
a receiving means which receives from a user an input of a country/region where said printer is used,
a storing means which stores a URL being associated with the country/region in the input thus received, with reference to data where the country/region and the URL (Uniform Resource Locators) are associated with each other in advance,
an obtaining means which obtains information regarding a consumption degree of the consumable item used in said printer, and
an accessing means which accesses a Web site where the consumable item is purchasable, the Web site being identified by the URL thus stored, when the consumption degree meets a standard which is obtained by a predetermined rule.

9. A printer host according to claim 8, wherein,
said receiving process which receives from the user the input of the country/region where said printer is used displays a country/region in selectable manner, based on said data where the country/region and the URL (Uniform Resource Locators) are associated with each other in advance.

10. A printer host according to claim 9, further comprising, a means which obtains country information set in said printer host, and said receiving process which receives from the user the input of the country/region where said printer is used displays the country/region under a condition that a country corresponding to the country information thus obtained is being selected.

11. A printer host according to claim 8, wherein,
said consumable item is an ink cartridge, and the consumption degree of said consumable item is expressed by an ink remaining amount.

12. A method which accesses a Web page where a consumable item is purchasable according to a degree of consumption of the consumable item used in a printer, comprising,
a storing process which receives from a user an input of the country/region where said printer is used, and stores a URL being associated in advance with the country/region thus received,
an obtaining process which obtains information regarding a consumption degree of said consumable item, and
an accessing process which accesses the Web site where the consumable item is purchasable, the Web site being identified by said URL thus stored, when the consumption degree meets a standard which is obtained by a predetermined rule.

13. A method which accesses the Web page according to claim 12, wherein,
said accessing process which accesses the Web site where said consumable item is purchasable is performed by an instruction from the user.

14. A method which accesses the Web page according to claim 12, wherein,
said receiving process which receives from the user the input of the country/region where the printer is used displays the country/region in selectable manner, based on data where the country/region and the URL (Uniform Resource Locators) are associated with each other in advance.

15. A method which accesses the Web page according to claim 14, further comprising
a means which obtains country information set in a printer host, wherein, said receiving process which receives from the user the input of the country/region where the printer is used displays the country/region under a condition that a country corresponding to the country information thus obtained is being selected.

16. A method which accesses the Web page according to claim 12, wherein,
said consumable item is an ink cartridge and the consumption degree of said consumable item is expressed by an ink remaining amount.
